(19) United States
(12) Patent Application Publication
(10) Pub. No.: US 2020/0303146 A1
(43) Pub. Date: Sep. 24, 2020

(54) CONTACT STRUCTURE AND SWITCH APPARATUS

(71) Applicant: Siemens Aktiengesellschaft, Muenchen (DE)

(72) Inventors: De Qiang DENG, Shanghai (CN); Ming LI, Shanghai (US); Yan Ling LIN, Shanghai (CN)

(73) Assignee: Siemens Aktiengesellschaft, Muenchen (DE)

(21) Appl. No.: 16/089,627

(22) PCT Filed: Mar. 28, 2017
(86) PCT No.: PCT/EP2017/057287

§ 371 Date: Sep. 28, 2018

(30) Foreign Application Priority Data
Mar. 29, 2016 (CN) 201610188243.1

(51) Int. Cl. H01H 50/58; H01H 1/02

(52) U.S. Cl. CPC H01H 50/58; H01H 1/02

(57) ABSTRACT

The contact structure includes a first contact, a second contact, a first contact arm and a second contact arm. In an embodiment, the first contact arm includes at least two spring plates, arranged one on top of another and fixed at one end. The second contact is located on the second contact arm. The first contact is located on the spring plate, on a side of the first contact arm relatively closer to the second contact arm. The at least two spring plates, under a driving action, experience elastic deformation which causes the first contact and the second contact to come into contact with each other. The switch apparatus includes at least one driver and the contact structure of an embodiment. An embodiment of the present solution can reduce the number of contacts in a contact structure.

### PRIORITY STATEMENT

This application is the national phase under 35 U.S.C. § 371 of PCT International Application No. PCT/EP2017/057287 which has an International filing date of Mar. 28, 2017, which designated the United States of America, and which claims priority under 35 U.S.C. § 119 to Chinese patent application No. 201610188243.1 filed Mar. 29, 2016, the entire contents of which are hereby incorporated herein by reference.

### FIELD

Embodiments of the present invention generally relates to the technical field of electronics and electricity, in particular to a contact structure and switch apparatus.

### BACKGROUND

A switch apparatus is an electrical device that is indispensable in an electric circuit. As a special class of switch apparatus, contactors and relays are widely used in many fields, such as electricity transmission, distribution and consumption. When a large-current circuit needs to use a contactor or a relay, a corresponding large-current contactor or large-current relay must be selected, to ensure that the contactor or relay can operate normally under a large current, and is not damaged by heat caused by a large current.

At present, to ensure that the contactor or relay can withstand a large current, the large-current contactor or large-current relay generally has a bridge contact structure comprising a thick conduction bridge. Two ends of the conduction bridge are each provided with at least one moving contact, which is moved by movement of the conduction bridge, to bring into contact or separate the moving contact and a corresponding static contact.

With regard to the prior art, the bridge contact structure at least comprises two moving contacts and two static contacts.

The contacts are generally made of a silver alloy material, but silver is a precious metal, with a high price. Since the number of contacts is large, a large amount of silver alloy must be consumed, and as a result, a switch apparatus with such a bridge contact structure has a high cost.

### SUMMARY

The present invention proposes a contact structure and a switch apparatus, which can reduce the number of contacts in a contact structure.

An embodiment of the present invention provides a contact structure, comprising:

a first contact, a second contact, a first contact arm and a second contact arm;

the first contact arm comprises at least two spring plates, which are arranged one on top of another and fixed to each other at one end;

the second contact is located on the second contact arm;

the first contact is located on the spring plate on that side of the first contact arm which is closer to the second contact arm; and

at least two spring plates included in the first contact arm, under a driving action, experience elastic deformation which causes the first contact and the second contact to come into contact with each other.

In one embodiment of the present invention,

the second contact arm is a conductor which has no elastic deformation capability; and

one end of the second contact arm is fixed in place, and the second contact is fixed to the other end of the second contact arm.

In another embodiment of the present invention,

the second contact arm comprises at least two spring plates, which are arranged one on top of another and fixed to each other at one end;

the second contact is located on the spring plate on that side of the second contact arm which is closer to the first contact arm; and

at least two spring plates included in the second contact arm, under a driving action, experience elastic deformation which causes the first contact and the second contact to come into contact with each other.

In one embodiment of the present invention, the length difference and width difference of any two of the spring plates arranged one on top of another are both smaller than a preset standard error value.

In one embodiment of the present invention, a groove is provided on that face of any one of the spring plates which is in contact with another spring plate.

In one embodiment of the present invention, the thickness of each of the spring plates is less than or equal to a predetermined critical thickness, so that the travel of the elastic deformation of each of the spring plates is greater than or equal to the contact travel between the first contact and the second contact.

In one embodiment of the present invention,

the second contact arm comprises at least two spring plates, which are arranged in parallel and connected together in sequence, with any two connected spring plates forming a “ [symbol] ” shaped structure;

the second contact is located on the spring plate on that side of the second contact arm which is closer to the first contact arm; and

at least two spring plates included in the second contact arm, under a driving action, experience elastic deformation which causes the first contact and the second contact to come into contact with each other.

Any two of the spring plates which are connected together are fixed by welding or riveting, or any two connected spring plates are formed by folding and bending an elongated piece of elastic material.

In one embodiment of the present invention, the material of the spring plate comprises: a copper alloy.

In one embodiment of the present invention, the material of the second contact arm comprises: a copper alloy.

An embodiment of the present invention also provides a switch apparatus, comprising:

at least one driver and any contact structure provided in an embodiment of the present invention; and

the driver is used for driving at least two spring plates included in the first contact arm in the contact structure.

In one embodiment of the present invention, when the second contact arm in the contact structure has elastic deformation capability, the driver is further used for driving the second contact arm.

An embodiment of the present invention provides a contact structure and a switch apparatus; the first contact arm comprises at least two spring plates, the first contact is disposed on the spring plate on the side closer to the second contact arm, and at least two spring plates included in the first contact arm experience elastic deformation under a driving action, causing the first contact to move, and realizing contact between the first contact and second contact.

Since the first contact arm comprises at least two spring plates fixed to each other at one end, the elastic deformation capability of the first contact arm is increased; the spring plates are disposed one on top of another, to ensure that the cross-sectional area of the first contact arm meets the requirements of a large current. Thus, the elastic deformation capability of the first contact arm is increased while ensuring that the cross-sectional area of the first contact arm meets the requirements of a large current. Hence, in large-current applications, the first contact can be brought into contact with the second contact through elastic deformation of the first contact arm. This contact structure only has one pair of contacts, so the number of contacts is reduced.

### BRIEF DESCRIPTION OF THE ACCOMPANYING DRAWINGS

To explain the technical solution in embodiments of the present invention or in the prior art more clearly, there follows a simple description of the accompanying drawings that need to be used in description of embodiments or the prior art. Obviously, the drawings in the description below are some embodiments of the present invention, and a person skilled in the art could obtain other drawings based on these drawings without expending any inventive effort.

FIG. 1 is a schematic diagram of a contact structure provided in one embodiment of the present invention;

FIG. 2 is a schematic diagram of a contact structure provided in another embodiment of the present invention;

FIG. 3 is a schematic diagram of a contact structure provided in another embodiment of the present invention;

FIG. 4 is a schematic diagram of a contact structure provided in another embodiment of the present invention;

FIG. 5 is a schematic diagram of a switch apparatus provided in one embodiment of the present invention;

FIG. 6 is a schematic diagram of a switch apparatus provided in another embodiment of the present invention.

### DETAILED DESCRIPTION OF EXAMPLE EMBODIMENTS

To clarify the object, technical solution and advantages of embodiments of the present invention, the technical solution in embodiments of the present invention is described clearly and completely in conjunction with the drawings in embodiments of the present invention. Obviously, the embodiments described are some, not all, of the embodiments of the present invention. Based on embodiments in the present invention, all other embodiments obtained by those skilled in the art without expending any inventive effort shall be included in the scope of protection of the present invention.

One embodiment of the present invention provides a contact structure, comprising: a first contact, a second contact, a first contact arm and a second contact arm; the first contact arm comprises at least two spring plates, which are arranged one on top of another and fixed to each other at one end; the second contact is located on the second contact arm; the first contact is located on the spring plate on that side of the first contact arm which is closer to the second contact arm; at least two spring plates included in the first contact arm, under a driving action, experience elastic deformation which causes the first contact and the second contact to come into contact with each other.

According to the invention embodiment described above, the first contact arm comprises at least two spring plates, the first contact is disposed on the spring plate on the side closer to the second contact arm, and at least two spring plates included in the first contact arm, under a driving action, experience elastic deformation, causing the first contact to move, and realizing contact between the first contact and second contact. Since the first contact arm comprises at least two spring plates fixed to each other at one end, the elastic deformation capability of the first contact arm is increased; the spring plates are disposed one on top of another, to ensure that the cross-sectional area of the first contact arm meets the requirements of a large current. Thus, the elastic deformation capability of the first contact arm is increased while ensuring that the cross-sectional area of the first contact arm meets the requirements of a large current. Hence, in large-current applications, the first contact can be brought into contact with the second contact through elastic deformation of the first contact arm. This contact structure only has one pair of contacts, so the number of contacts is reduced.

In one embodiment of the present invention, the form of the second contact arm is not defined. The second contact arm may have no elastic deformation capability, and be in a stationary state during the process of establishing contact between or separating the first contact and the second contact. Alternatively, the second contact arm may have elastic deformation capability, and experience elastic deformation under a driving action during the process of establishing contact between or separating the first contact and the second contact. Depending on whether the second contact arm has elastic deformation capability, the contact structure provided in an embodiment of the present invention can be realized in the following two manners:

manner A: the second contact arm has no elastic deformation capability; and

manner B: the second contact arm has elastic deformation capability.

The realizations of the contact structures in manner A and manner B are explained separately below.

### With Regard to Manner A

In manner A, the case where the first contact arm comprises two spring plates is taken as an example; see FIG. 1 for this contact structure. As shown in FIG. 1, the contact structure comprises: a first contact arm 101, a second contact arm 102, a first contact 103 and a second contact 104, wherein

the first contact arm 101 comprises: a spring plate 1011 and a spring plate 1012, which are arranged one on top of another, with one end of the spring plate 1011 and one end of the spring plate 1012 both being fixed to a support 108 via a screw 105;

the first contact 103 is fixed to that side of the spring plate 1011 which is closer to the second contact arm 102;

the second contact arm 102 is fixed to a support 108 via a screw 106; and

the second contact 104 is fixed to that side of the second contact arm 102 which is closer to the first contact arm 101.

In an embodiment of the present invention, the first contact arm 101 is composed of the spring plate 1011 and the spring plate 1012. The spring plate 1011 and the spring plate 1012 experience bending deformation under a driving action, causing the first contact 103 to move towards the second contact 104. The second contact arm 102 is in a stationary state, until the first contact 103 comes into contact with the second contact 104. By designing the first contact arm 101 to take the form of two spring plates, the elastic deformation capability of the first contact arm 101 is increased while keeping the current-carrying ability of the first contact arm 101 unchanged, so as to have the ability to establish contact between the first contact 103 and second contact 104 through elastic deformation. Thus, a contact structure used in the field of large-currents can have just one pair of contacts, so the number of contacts is reduced relative to the prior art.

There follows a more detailed explanation of the principle whereby the elastic deformation capability of the first contact arm 101 can be increased while keeping the current-carrying ability unchanged.

Formula one below shows that the resistance of a material is directly proportional to the length of the material, and inversely proportional to the cross-sectional area of the material; the cross-sectional area of a material is directly proportional to the width and thickness of the material. To guarantee the current-carrying ability of a material, the resistance of the material must be kept at a low level, so the cross-sectional area of the material must attain a certain value if the length of the material remains unchanged.

Formula one is as follows:

$$R = ρ \cdot \frac{L}{S} = \frac{L}{T \cdot B}$$

where R is the resistance of the material, ρ is the resistivity of the material, L is the length of the material, S is the cross-sectional area of the material, T is the thickness of the material, and B is the width of the material.

Formula two below shows that the amount of deformation of a material is directly proportional to the driving force to which the material is subjected and the cube of the material length, and inversely proportional to the elastic modulus and sectional inertia of the material; the sectional inertia of the material is directly proportional to the width and the cube of the thickness of the material. To increase the elastic deformation capability, the thickness of the material must be made less than a given value if the length and width of the material are kept unchanged.

Formula two is as follows:

$$Y = \frac{F \cdot {L}^{3}}{3 E \cdot I} = \frac{4 F \cdot {L}^{3}}{E \cdot B \cdot {T}^{3}}$$

where Y is the amount of deformation of the material, F is the driving force to which the material is subjected, L is the length of the material, E is the elastic modulus of the material, I is the sectional inertia of the material, B is the width of the material, and T is the thickness of the material.

Comparing the dual-spring-plate first contact arm 101 with the conduction arm in a bridge contact structure, according to formula one, since the spring plate 1011 and spring plate 1012 are in tight contact after being laid one on top of another, the sum of the cross-sectional areas of the spring plate 1011 and spring plate 1012 is equal to the cross-sectional area of the conduction bridge. Thus, the cross-sectional area of the first contact arm 101 has not changed, so the resistance of the first contact arm 101 has not changed either, thereby ensuring that the current-carrying ability of the first contact arm 101 does not change.

According to formula two, since the sum of the thicknesses of the spring plate 1011 and spring plate 1012 is equal to the thickness of the conduction bridge, and the amount of deformation of the spring plate is inversely proportional to the cube of the thickness of the spring plate, if the thickness of the spring plate 1011 and the thickness of the spring plate 1012 are each equal to one half of the thickness of the conduction bridge, the driving force needed to cause the spring plate 1011 or spring plate 1012 to experience an amount of deformation the same as that of the conduction bridge is only one eighth of that in the case of the conduction bridge, and the sum of the driving forces needed by the spring plate 1011 and spring plate 1012 is one quarter of that in the case of the conduction bridge, so the elastic deformation capability of the first contact arm 101 is increased. In summary, by cutting the first contact arm 101 into the spring plate 1011 and spring plate 1012, the elastic deformation capability of the first contact arm 101 is increased, while ensuring that the current-carrying ability remains unchanged.

In an embodiment of the present invention, to ensure that the first contact 103 can come into contact with the second contact 104, and the spring plates do not exceed elastic limits during deformation, each spring plate must have sufficient elastic deformation capability. According to formula two, the smaller the thickness of the spring plate, the smaller the tension arising through deformation. Based on the size of current borne by the contact structure, an initial distance between the two contacts when the contact arms are not driven is determined. A critical thickness of each spring plate is determined according to the initial distance between the two contacts. The thickness of each spring plate cannot exceed the critical thickness, but no restriction is imposed in terms of whether the thicknesses of the spring plates are equal.

It must be explained that the embodiment shown in FIG. 1 is just one feasible embodiment of the present invention. The first contact arm may comprise a greater number of spring plates according to actual service requirements, to further increase the elastic deformation capability of the first contact arm.

In an embodiment of the present invention, as shown in FIG. 1, a wiring board 107 is further disposed between the first contact arm 101 and support 108. The wiring board 107 is in contact with the first contact arm 101, and used for connecting to an external input electrode. The second contact arm 102 is connected to a corresponding output electrode. Under the action of a driving force, the spring plate 1011 and spring plate 1012 bend towards the second contact arm 102. When the first contact 103 and second contact 104 have come into contact with each other, the spring plate 1011 and spring plate 1012 are in tight contact with each other, connecting the input electrode to the output electrode.

### With Regard to Manner B

In manner B, the second contact arm has elastic deformation capability. The second contact arm may have the same structure as the first contact arm, or another form of structure. The contact structure in manner B can be divided into the following two forms, according to the form of the second contact arm:

first form: the second contact arm comprises at least two spring plates, the specific structure being the same as that of the first contact arm; and

second form: the second contact arm comprises at least two spring plates, which are arranged in parallel and connected together in sequence, with any two connected spring plates forming a “ [symbol] ” shaped structure.

The two forms in manner B are explained separately below.

### With Regard to the First Form in Manner B

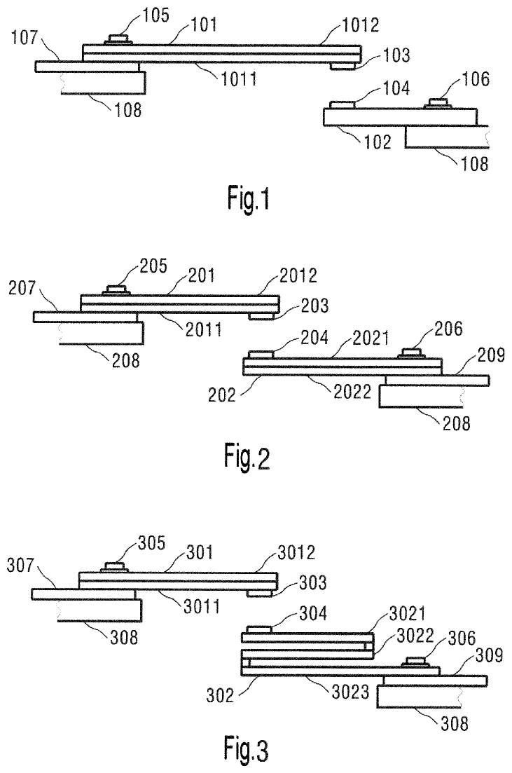

The case of the first contact arm and the second contact arm each comprising two spring plates is taken as an example; see FIG. 2 for this contact structure. As shown in FIG. 2, the contact structure comprises: a first contact arm 201, a second contact arm 202, a first contact 203 and a second contact 204, wherein the first contact arm 201 comprises: a spring plate 2011 and a spring plate 2012, which are arranged one on top of another, with one end of the spring plate 2011 and one end of the spring plate 2012 both being fixed to a support 208 via a screw 205; the first contact 203 is fixed to that side of the spring plate 2011 which is closer to the second contact arm 202; the second contact arm 202 comprises: a spring plate 2021 and a spring plate 2022, which are arranged one on top of another, with one end of the spring plate 2021 and one end of the spring plate 2022 both being fixed to a support 208 via a screw 206; the second contact 204 is fixed to that side of the spring plate 2021 which is closer to the first contact arm 201;

The spring plate 2011 and spring plate 2012 experience bending deformation towards the second contact arm 202 under a driving action, causing the first contact 203 to move towards the second contact arm 202, and the spring plate 2021 and spring plate 2022 experience bending deformation towards the first contact arm 201 under a driving action, causing the second contact 204 to move towards the first contact arm 201, until the first contact 203 and second contact 204 come into contact with each other. The first contact arm 201 and second contact arm 202 both have a dual-spring-plate structure, so the elastic deformation capability of the first contact arm 201 and second contact arm 202 are increased while keeping the current-carrying ability of the first contact arm 201 and second contact arm 202 unchanged. Thus, the two contacts can be caused to come into contact or separated by causing elastic deformation of the two contact arms. Compared with the bridge structure in the prior art, this contact structure needs just one pair of contacts, so the number of contacts is reduced.

In an embodiment of the present invention, as FIG. 2 shows, a first wiring board 207 is further disposed between the first contact arm 201 and support 208, with the first wiring board 207 being in contact with the first contact arm 201; a second wiring board 209 is further disposed between the second contact arm 202 and support 208, the second wiring board 209 being in contact with the second contact arm 202. The first wiring board 207 and second wiring board 209 are used for connecting an external input electrode and an output electrode respectively. A good contact can be ensured between the contact arm and the electrode via the wiring board, preventing a bad contact from occurring between the contact arm and the electrode during deformation of the contact arm.

In an embodiment of the present invention, the first contact arm 201 and the second contact arm 202 can both experience elastic deformation, causing the first contact 203 and the second contact 204 to move. Since the two contact arms can both experience elastic deformation, compared to the contact structure in manner A, the cross-sectional area of the two contact arms and the initial distance between the two contacts when the contact arm is not being driven can be increased, thereby enabling the contact structure to withstand a larger current.

### With Regard to the Second Form of Manner B

The case where the first contact arm comprises two spring plates and the second contact arm comprises three spring plates is taken as an example; see FIG. 3 for this contact structure.

As shown in FIG. 3, the contact structure comprises: a first contact arm 301, a second contact arm 302, a first contact 303 and a second contact 304, wherein the first contact arm 301 comprises: a spring plate 3011 and a spring plate 3012, which are arranged one on top of another, with one end of the spring plate 3011 and one end of the spring plate 3012 both being fixed to a support 308 via a screw 305; the first contact 303 is fixed to that side of the spring plate 3011 which is closer to the second contact arm 302; the second contact arm 302 comprises: a spring plate 3021, a spring plate 3022 and a spring plate 3023; the spring plate 3021, spring plate 3022 and spring plate 3023 are arranged in parallel and connected together in sequence; the spring plate 3021 and spring plate 3022 forma “ [symbol] ” shaped structure, the spring plate 3022 and spring plate 3023 form a “ [symbol] ” shaped structure, and one end of the spring plate 3023 is fixed to the support 308 via a screw 306; the second contact 304 is fixed to that side of the spring plate 3021 which is closer to the first contact arm 301.

The spring plate 3011 and spring plate 3012 experience bending deformation towards the second contact arm 302 under the action of a driving force, causing the first contact 303 to move towards the second contact arm 302; the spring plate 3021, spring plate 3022 and spring plate 3023 each experience bending deformation under the action of a driving force; the included angle between the spring plate 3021 and spring plate 3022 and the included angle between the spring plate 3022 and spring plate 3023 both increase; the entire second contact arm 302 extends towards the first contact arm 301, causing the second contact 304 to move towards the first contact arm 301, until the first contact 303 and the second contact 304 come into contact with each other. The elastic deformation capability of the first contact arm 301 is increased while ensuring current-carrying ability via the dual-spring-plate structure, and the second contact arm 302 adds together the elastic deformations of multiple spring plates, increasing the elastic deformation capability of the second contact arm 302, so that the two contacts are caused to come into contact with each other through the elastic deformation of the first contact arm 301 and second contact arm 302. Thus the contact structure only has one pair of contacts, so the number of contacts is reduced relative to the bridge structure in the prior art.

In an embodiment of the present invention, the three spring plates included in the second contact arm 302 are arranged in parallel and connected to each other in sequence, so that two adjacent spring plates form a “ [symbol] ” shaped structure. The entire second contact arm 302 forms a structure of a spring; under the action of a driving force, each spring plate experiences a certain amount of elastic deformation, with the amount of deformation of the second contact arm 302 being equal to the sum of the amounts of deformation of the spring plates. Thus, spring plates with poor elastic deformation capability are combined, increasing the elastic deformation capability of the second contact arm 302, and ensuring that the total travel of the first contact arm 301 and second contact arm 302 can cause the two contacts to come into contact with each other.

In an embodiment of the present invention, in the second contact arm 302, two connected spring plates can be fixed by riveting or welding, or a longer elastic material may be bent and folded to form two spring plates, thereby reducing the process step of fixing together two connected spring plates, and reducing the cost of the contact structure.

In one embodiment of the present invention, to ensure that spring plates disposed one on top of another can be in good contact, a groove may be provided on that face of any spring plate which is in contact with another spring plate. In this way the contact performance between spring plates arranged one on top of another can be improved. The case of the contact structure shown in FIG. 1 is taken as an example below, and the realization of a spring plate provided with a groove is explained further.

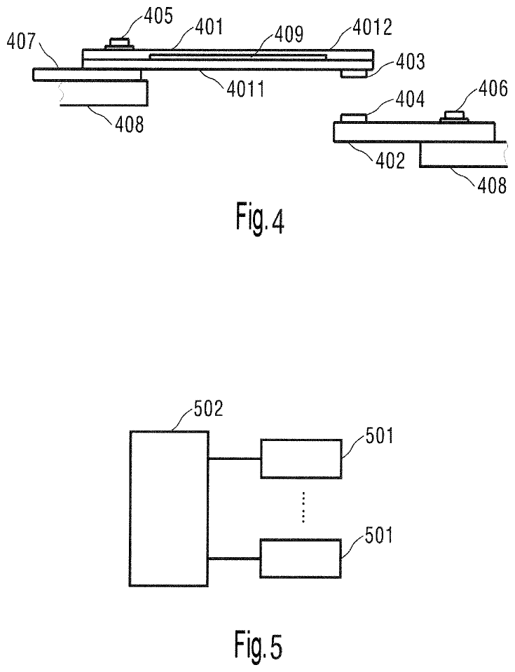

As FIG. 4 shows, one embodiment of the present invention provides a contact structure, comprising: a first contact arm 401, a second contact arm 402, a first contact 403 and a second contact 404, wherein the first contact arm 401 comprises: a spring plate 4011 and a spring plate 4012, which are arranged one on top of another, with one end of the spring plate 4011 and one end of the spring plate 4012 both being fixed to a support 408 via a screw 405, and a groove 409 being provided on that face of the spring plate 4012 which is in contact with the spring plate 4011; the first contact 403 is fixed to that side of the spring plate 4011 which is closer to the second contact arm 402; the second contact arm 402 is fixed to a support 408 via a screw 406; the second contact 404 is fixed to that side of the second contact arm 402 which is closer to the first contact arm 401.

In an embodiment of the present invention, the spring plate 4011 and spring plate 4012 experience bending deformation towards the second contact arm 402 after being subjected to the action of a driving force; under the action of the driving force, the spring plate 4012 decreases the gap between itself and the spring plate 4011.

Due to the presence of the groove 409, the positions where the spring plate 4012 and spring plate 4011 are in contact with each other are two rectangular regions, avoiding bad contact caused by the surfaces of the spring plate 4011 and spring plate 4012 not being level. Once the first contact 403 is in contact with the second contact 404, the spring plate 4011 and spring plate 4012 remain in a state of tight contact under the action of the driving force, until the driving force is removed, when the spring plate 4011 and spring plate 4012 move in the direction away from the second contact arm 402 under the action of their respective restoring elastic forces.

According to the embodiments described above, amongst the spring plates which are arranged one on top of another, the length difference or width difference of any two spring plates is in each case smaller than a preset standard error value. Thus, since the spring plates arranged one on top of another are fixed together at one end, the fixed ends are at the same electric potential, and the length difference and width difference of any two spring plates arranged one on top of another are both smaller than a preset standard error value, so the potential difference of various contact positions on two adjacent spring plates does not exceed a critical voltage for arcing, thereby avoiding the phenomenon of arcing between spring plates due to an excessively large potential difference, and increasing the safety of the contact structure.

According to the embodiments described above, the spring plates included in the first contact arm and second contact arm experience elastic deformation after being subjected to a driving force action, so that the two contacts come into contact with each other; once the driving action has been removed, each spring plate returns to a free state under the action of its own restoring elastic force, causing the two contacts to move away from each other, and realizing the separation of the two contacts.

According to the embodiments described above, to ensure that the spring plate has good conductivity and good elasticity, the spring plate is made of a copper alloy material; when the second contact arm has no elastic deformation capability, the second contact arm is a single conductor made of a copper alloy material.

As FIG. 5 shows, one embodiment of the present invention provides a switch apparatus, comprising: at least one driver 501 and any contact structure 502 provided in an embodiment of the present invention;

the driver 501 is used for driving at least two spring plates included in the first contact arm in the contact structure 502.

In one embodiment of the present invention, when the second contact arm in the contact structure 502 has elastic deformation capability, the driver 501 is further used for driving the second contact arm.

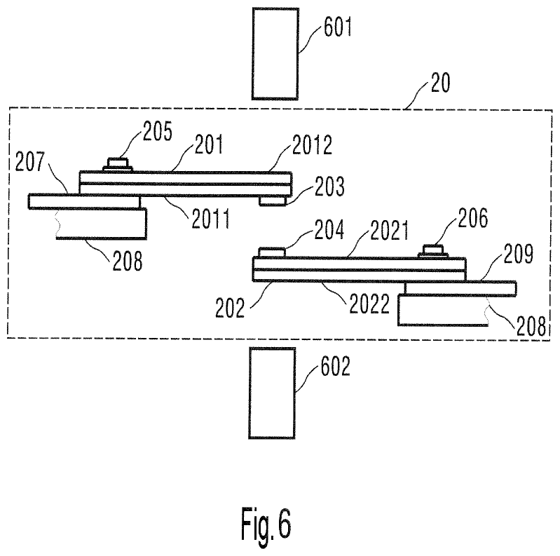

To clarify the realization of the contact structure and switch apparatus provided in embodiments of the present invention, the switch apparatus provided in an embodiment of the present invention is explained in further detail below in conjunction with the contact structure shown in FIG. 2. As FIG. 6 shows, one embodiment of the present invention provides a switch apparatus, comprising:

the contact structure 20, a first driver 601 and a second driver 602;

the first driver 601 is disposed on one side of the first contact arm 201 in the contact structure 20, and is used for applying an electromagnetic driving force to the spring plate 2011 and spring plate 2012; and

the second driver 602 is disposed on one side of the second contact arm 202 in the contact structure 20, and is used for applying an electromagnetic driving force to the spring plate 2021 and spring plate 2022.

In one embodiment of the present invention, after being triggered, the first driver 601 applies an electromagnetic force, directed towards the second contact arm 202, to the spring plate 2011 and spring plate 2012 respectively; under the action of the electromagnetic force applied by the first driver 601, the spring plate 2011 and spring plate 2012 experience bending deformation towards the second contact arm 202. After being triggered, the second driver 602 applies an electromagnetic force, directed towards the first contact arm 201, to the spring plate 2021 and spring plate 2022 respectively; under the action of the electromagnetic force applied by the second driver 602, the spring plate 2021 and spring plate 2022 experience bending deformation towards the first contact arm 201.

The first contact 203, driven by the spring plate 2011, moves towards the second contact arm 202, and the second contact 204, driven by the spring plate 2021, moves towards the first contact arm 201, until the first contact 203 and the second contact 204 come into contact with each other. At this time, the spring plate 2012 is in tight contact with the spring plate 2011 under the action of the electromagnetic force of the first driver 601, and the spring plate 2022 is in tight contact with the spring plate 2021 under the action of the electromagnetic force of the second driver 602; the spring plate 2011 and spring plate 2012 jointly carry the current flowing through the first contact arm 201, and the spring plate 2021 and spring plate 2022 jointly carry the current flowing through the second contact arm 202. When the first driver 601 and second driver 602 have stopped applying the electromagnetic force, the spring plate 2011 and spring plate 2012 move in a direction away from the second contact arm 202 under the action of their own elastic forces, the spring plate 2021 and spring plate 2022 move in a direction away from the first contact arm 201 under the action of their own elastic forces, and the first contact 203 and second contact 204 separate, driven by the spring plate 2011 and spring plate 2021.

Based on the embodiments described above, embodiments of the present invention have at least the following beneficial effects:

1. In an embodiment of the present invention, the first contact arm comprises at least two spring plates, the first contact is disposed on the spring plate on the side closer to the second contact arm, and at least two spring plates included in the first contact arm experience elastic deformation under a driving action, causing the first contact to move, and realizing contact between the first contact and second contact. Since the first contact arm comprises at least two spring plates fixed to each other at one end, the elastic deformation capability of the first contact arm is increased; the spring plates are disposed one on top of another, to ensure that the cross-sectional area of the first contact arm meets the requirements of a large current. Thus, the elastic deformation capability of the first contact arm is increased while ensuring that the cross-sectional area of the first contact arm meets the requirements of a large current. Hence, in large-current applications, the first contact can be brought into contact with the second contact through elastic deformation of the first contact arm. This contact structure only has one pair of contacts, so the number of contacts is reduced.

2. In an embodiment of the present invention, the first contact arm is formed by arranging multiple spring plates one on top of another, so that a contact structure comprising just one pair of contacts can be used in the field of large currents. The amount of the precious metal silver is reduced by reducing the number of contacts, thereby reducing the cost of the switch apparatus in applications in the field of large currents.

3. In an embodiment of the present invention, the form of the second contact arm is not defined. The second contact arm may have no elastic deformation capability, so that the first contact arm causes the first contact to come into contact with or separate from the stationary second contact. Alternatively, the second contact arm may have elastic deformation capability, and the second contact arm causes the second contact to move while the first contact arm causes the first contact to move, realizing contact between or separation of the first contact and second contact. Thus, the form of the second contact arm can be determined flexibly according to demands, so the adaptability of the contact structure is increased.

4. In an embodiment of the present invention, when the second contact arm has elastic deformation capability, the second contact arm may have the same form as the first contact arm, being formed of multiple spring plates arranged one on top of another. The second contact arm may also be formed by arranging multiple spring plates in parallel and connecting them together in sequence. The form of the second contact arm may be chosen flexibly according to the installation position of the contact structure and the size of current carried, thereby further increasing the adaptability of the contact structure.

5. In an embodiment of the present invention, the length difference and width difference between spring plates arranged one on top of another are both smaller than a preset standard error value. Since the spring plates arranged one on top of another each have one end connected to the wiring board, those ends of the stacked spring plates which are connected to the wiring board are at the same potential. Since the length difference and width difference between spring plates arranged one on top of another are both smaller than a preset standard error value, it can be ensured that the potential difference at the position of contact between any two spring plates arranged one on top of another will not exceed a critical voltage for arcing, avoiding the phenomenon of arcing between two spring plates in contact with each other during the process of establishing contact between or separating the two contacts, and thereby increasing the safety of the contact structure and switch apparatus.

6. In an embodiment of the present invention, when multiple spring plates are arranged one on top of another, a groove may be provided on that face of any spring plate which is in contact with another spring plate. Thus, two spring plates are only in contact with each other at two ends; this can improve the contact between spring plates, ensure that the contact arm can transmit and withstand large currents normally, and increase the reliability of the contact structure and switch apparatus.

It must be explained that relationship terms such as “first” and “second” as used herein are merely intended to distinguish one entity or operation from another entity or operation, and do not necessarily require or imply the existence of any such actual relationship or order between these entities or operations. Moreover, the terms “comprise” and “include”, or any other variant thereof, are intended to cover non-exclusive inclusion, so that a process, method, article or device which comprises a series of key elements does not comprise these key elements alone, but also comprises other key elements which are not listed explicitly, or also comprises intrinsic key elements of this process, method, article or device. In the absence of further restrictions, a key element defined by the statement “comprises a . . . ” does not exclude the existence of another identical element in the process, method, article or device which comprises the key element.

Finally, it must be explained that the embodiments above are merely preferred embodiments of the present invention, which are merely intended to explain the technical solution of the present invention, and are not intended to define the scope of protection of the present invention. Any amendments, equivalent substitutions or improvements etc. made within the spirit and principles of the present invention shall be included in the scope of protection thereof.

1. A contact structure, comprising:
a first contact;
a second contact;
a first contact arm; and
a second contact arm; wherein
the first contact arm comprises at least two spring plates, one spring plate of the at least two spring plates being arranged on top of and fixed to another spring plate of the at least two spring plates at one end;
the second contact is located on the second contact arm;
the first contact is located on a spring plate, of the at least two spring plates, on a side of the first contact arm relatively closer to the second contact arm; and
the at least two spring plates of the first contact arm, under a driving action, being configured to experience elastic deformation to cause the first contact to come into contact with the second contact.

2. The contact structure of claim 1, wherein
the second contact arm is a conductor including no elastic deformation capability; and
one end of the second contact arm is fixed in place, and the second contact is fixed to another end of the second contact arm.

3. The contact structure of claim 1, wherein
the second contact arm comprises at least two spring plates, one spring plate of the at least two spring plates of the second contact arm being arranged on top of and fixed to another spring plate, of the at least two spring plates of the second contact arm, at one end;
the second contact is located on spring plate, of the at least two spring plates of the second contact arm, on a
side of the second contact arm relatively closer to the first contact arm; and
the at least two spring plates of the second contact arm, under a driving action, being configured to experience elastic deformation to cause the first contact and the second contact to come into contact with each other.

4. The contact structure of claim 1, wherein
a length difference and a width difference of two of the at least two spring plates, arranged on top of another spring plate of the at least two spring plates, are relatively smaller than a standard error value.

5. The contact structure of claim 1, wherein
a thickness of each of the at least two spring plates is less than or equal to a critical thickness, such that travel of the elastic deformation of each of the at least two spring plates is relatively greater than or equal to contact travel between the first contact and the second contact.

6. The contact structure of claim 1, wherein
the second contact arm comprises at least two spring plates, arranged in parallel and connected together in sequence, two connected spring plates of the at least two spring plates forming a “ [symbol] ” shaped structure;
the second contact is located on a spring plate of the at least two spring plates, on a side of the second contact arm relatively closer to the first contact arm; and
at least two spring plates of the second contact arm, under a driving action, being configured to experience elastic deformation causing the first contact and the second contact to come into contact.

7. The contact structure of claim 6, wherein
two of the at least two spring plates, connected together, are fixed by welding or riveting.

8. The contact structure of claim 1, wherein at least one of:
a material of at least one of the at least two spring plates comprise a copper alloy;
and
a material of the second contact arm comprises a copper alloy.

9. A switch apparatus, comprising:
at least one driver; and
the contact structure claim 1,
the at least one driver is configured to drive the at least two spring plates of the first contact arm in the contact structure.

10. The switch apparatus of claim 9, wherein
upon the second contact arm of the contact structure including elastic deformation capability,
the at least one driver is further configured to drive the second contact arm.

11. The contact structure of claim 1, wherein
a groove is provided on a face of the at least two spring plates in contact with another of the at least two spring plates.

12. The contact structure of claim 4, wherein
a groove is provided on a face of the at least two spring plates in contact with another of the at least two spring plates.

13. The contact structure of claim 6, wherein
two connected spring plates of the at least two spring plates, are formed by folding and bending an elongated piece of elastic material.

14. A switch apparatus, comprising:
at least one driver; and
the contact structure of claim 2, the at least one driver is configured to drive the at least two spring plates of the first contact arm in the contact structure.

15. The switch apparatus of claim 14, wherein
upon the second contact arm of the contact structure including elastic deformation capability, the at least one driver is further configured to drive the second contact arm.

16. A switch apparatus, comprising:
at least one driver; and
the contact structure of claim 3, the at least one driver is configured to drive the at least two spring plates of the first contact arm in the contact structure.

17. The switch apparatus of claim 16, wherein
upon the second contact arm of the contact structure including elastic deformation capability, the at least one driver is further configured to drive the second contact arm.
